(19) United States
(12) Patent Application Publication
(10) Pub. No.: US 2014/0015551 A1
(43) Pub. Date: Jan. 16, 2014

(54) SALINITY SENSOR FOR EMBEDDED ENVIRONMENTAL MONITORING

(71) Applicants: Samuel H. Russ, Mobile, AL (US); Silas Leavesly, Mobile, AL (US); Brian Durden, Melbourne, FL (US)

(72) Inventors: Samuel H. Russ, Mobile, AL (US); Silas Leavesly, Mobile, AL (US); Brian Durden, Melbourne, FL (US)

(21) Appl. No.: 13/980,040

(22) PCT Filed: Mar. 17, 2011
(86) PCT No.: PCT/US2011/028849

§ 371 Date: Jul. 16, 2013

Related U.S. Application Data
(60) Provisional application No. 61/340,390, filed on Mar. 17, 2010.

(51) Int. Cl. G01N 27/06

(52) U.S. Cl. CPC G01N 27/06
USPC 324/693; 324/723

(57) ABSTRACT

The invention is a method of measuring salinity that presents an alternative to conventional salinity sensors that require AC voltage to measure salinity. The use of AC voltage is undesirable due to the need for two accurate analog measurements (current and voltage) and, in the case of computer based measurements both analog measurements must be converted to a digital signal.

### RELATED APPLICATIONS

This application claims the benefit of priority to U.S. Provisional Patent Application Ser. No. 61/340,390, filed Mar. 17, 2010.

### FIELD OF THE INVENTION

This invention relates to an embedded environmental sensor which has the ability to measure salinity. More specifically, this invention is a low-cost sensor that combines an H-bridge and digital potentiometer to make an AC resistance measurement suitable for measuring salinity.

### BACKGROUND OF THE INVENTION

Environmental sensing is a common application for small embedded systems. Successful designs must consume little power, have low cost, and be relatively small and light. There is significant interest in developing a system to measure water level in response to wind-forcing events. Since water density is a function of salinity, and since the correlation of water pressure to water depth is a function of density, an important element of the sensor gear is the ability to measure salinity.

Sensing the environment can be carried out through remote measurements (e.g. satellites) and through in situ measurements (e.g. wireless sensor networks). Both have been demonstrated successfully as means of measuring characteristics of water.

For example, in [1], Landsat measurements of an area before and after flooding were used to estimate the extent of flood waters. In [2], a wireless sensor network was deployed to measure water quality, and in [3], a wired sensor network.

Remote sensing has the advantage of broader coverage, but is often constrained by lack of line-of-sight (e.g. cloud cover) and an inability to penetrate below the surface. Even with sophisticated satellite capabilities, there is a significant need for in situ monitoring of environmental parameters by embedded sensors.

An example of one real-time water-sensor architecture is the Land/Ocean Biogeochemical Observatory (LOBO) system developed by Satlantic and the Monterrey Bay Aquarium Research Institute (MBARI) [4, 5]. The sensor measures several properties of the water, including turbidity, temperature, salinity, and chlorophyll content, and has a GSM (cellular) modem for real-time data transmission. The Sanibel-Captiva Conservation Foundation (SCCF) has installed the LOBO units to create the real-time River, Estuary, and Coastal Observing Network (RECON) to monitor water around Sanibel Island and the surrounding area [6].

A common requirement for measurement is the height of water. Besides the obvious application in measuring the height of flood waters, water level is often manipulated in shallow bodies of water by wind and tidal forcing.

It is interesting to note that satellite measurements of water levels are unsatisfactory for two reasons. First, clouds tend to obscure direct observation. For example, in [1] the authors were forced to use satellite measurements made before and well after a flooding event because of cloud cover. The ironic issue is that flooding tends to happen under cover of clouds. Second, measurement of water level may have to be estimated from knowledge of the terrain [1] rather than measured directly. There is a consequent strong motivation for direct sensing of water level in situ.

One method for sensing water height is a sonar measurement of the floor of the body of water [7]. This is relatively expensive and requires either multiple sonar units or a mobile platform to sense water height over an entire body of water.

There is a strong motivation to improve the forecasting of water levels and water characteristics (e.g. temperature and salinity) in shallow estuaries. Simulating and forecasting the environment of estuaries is especially challenging because estuaries are situated between incoming rivers and large bodies of salt water such as an ocean or gulf and because the shallow structure causes a great deal of variation in water level as a function of wind, tides, and forcing from incoming rivers.

Computer models of estuaries, such as Mobile Bay, need refinement, and so the work outlined in this paper began with the motivation to measure water height, salinity, and temperature to improve simulation models. For example, there is disagreement whether wind forcing or river discharge dominates the dynamics of Mobile bay [8, 9]. Data obtained using the sensors will be used to parameterize a linear approximation of a static momentum balance of the estuary [10] to improve simulation and forecasting accuracy.

Embedded salinity sensors have been used in a variety of applications, including sensing of road conditions in the presence of low temperatures and salting [12].

An ideal sensor should be able to measure water height both when located above water and when submerged, as water height can vary dramatically in large, shallow bodies of water. The sensor should be able to run unattended for months and, if possible, transmit data real-time.

The PILS (Pressure-Induced water-Level Sensor) system is designed to accomplish that. It includes a sonar unit for measuring height above water and a pressure transducer for measuring depth below water.

For example, when located above water, the unit should use a simple sonar transducer to obtain a sound reflection off of the surface of the water through air. A model that is popular in robotics applications has been selected.

In order to use a pressure sensor to make an accurate measure of depth, the conversion of water pressure to depth must take into account the density of the water. However, the salinity of the water must be measured because water density varies with salinity. (An equation relating density to salinity can be found in [11].) Measuring salinity can entail measuring the temperature and electrical resistance of the water.

### SUMMARY OF THE INVENTION

The present invention involves a process or method of measuring the resistance of a fluid comprising the steps of (a) providing a bridge circuit consisting of two known resistances, one digitally controlled resistance, one set of electrodes in contact in the fluid to be measured, and an analog comparator that provides an output compatible with digital logic levels, (b) providing means of reversing the polarity of the voltage applied to the bridge, (c) varying the digitally controlled resistance and observing the digital output of the analog comparator, (d) observing the resistance setting of the digitally controlled resistance at the point of logic transition of the comparator, and (e) utilizing the resistance setting and the known properties of the bridge circuit to calculate the resistance of the fluid

In one embodiment of the present invention, the method further comprises the step of using the electrodes' known cell constant to calculate the bulk conductivity of the fluid. Further in the embodiment, the present invention there can be an additional step of utilizing the bulk conductivity to estimate the fluid's salinity.

In another embodiment of the present invention, the digitally controlled resistance is a digital potentiometer.

In another embodiment of the present invention, the digitally controlled resistance is multiple digital potentiometers wired together.

In another embodiment of the present invention, the fluid is seawater or other naturally occurring water.

In another embodiment of the present invention, the electrodes are made of non-corrosive material.

In another embodiment of the present invention, the means of reversing the polarity is an H-bridge.

In another embodiment of the present invention, the means of reversing the polarity is a transistor network.

In another embodiment of the present invention, the means of reversing the polarity is digitally controlled.

In another embodiment of the present invention, at least one of the digitally controlled resistance, H-bridge, and analog comparator is built into a microprocessor.

In another embodiment of the present invention, a shift register is added to reduce the number of output pins needed by the computer that is controlling the circuit.

The present invention is also an apparatus for measuring the resistance of a fluid. The components of the apparatus are (a) a bridge circuit consisting of two known resistances, one digitally controlled resistance, one set of electrodes in contact in the fluid to be measured, and an analog comparator that provides an output compatible with digital logic levels; (b) a means for reversing the polarity of the voltage applied to the bridge; (c) means for varying the digitally controlled resistance and observing the digital output of the analog comparator; (d) means for observing the resistance setting of the digitally controlled resistance at the point of logic transition of the comparator; and (e) means for utilizing said resistance setting and the known properties of the bridge circuit to calculate the resistance of the fluid.

### BRIEF DESCRIPTION OF THE DRAWINGS

FIG. 1 is a block diagram of a salinity sensor.

FIG. 2 is the conductance of water versus salinity at a cell constant of 0.0867.

### DETAILED DESCRIPTION OF THE INVENTION

Salt increases the conductivity of water by providing ions for the flow of electric current. Hence the salinity of water can be inferred from measuring the conductivity of a sample.

The measurement process uses a set of electrodes of known geometry and is usually calibrated ahead of time using solutions of known salinity. By calibrating the electrodes, the cell constant (the ratio of electrode spacing to electrode area) is calculated.

It is well known that the resistance, R, of a substance is calculated as follows.

$$R = ρ \frac{l}{A} , \qquad ( 1 )$$

where ρ is the bulk resistivity of the material, l is the length of the material, and A is the area of the material. l/A, then, is the cell constant C which has units of reciprocal-length (e.g. cm⁻¹ in CGS). In the case of a fluid, l and A are the spacing and area of the electrodes, respectively.

The conductivity of a fluid, G, is the reciprocal of the resistance and the bulk conductivity, σ, is the reciprocal of the bulk resistivity, and so (1) can be re-written as

σ/G=C. (2)

From (1) it is clear that knowing the cell constant and measuring the resistance enables calculation of the bulk resistivity of a material. Conversely, from (2), the cell constant of a measuring device can be calculated from the known bulk conductivity of a material and its conductance as measured by the device.

In a preferred embodiment of the present invention, it is suitable to follow the convention of referring to the actual, measured conductance between two electrodes as conductance and the intrinsic conductance of a material as conductivity or bulk conductivity. Bulk conductivity has units of mS/cm.

One skilled in the art would recognize that there is a standard set of equations that estimate the salinity and density of seawater using the conductivity of the water. So the measurement of salinity consists of a few steps. First, the water temperature and electrical resistance between electrodes of a known cell constant are measured. Second, the cell constant C is used to calculate the bulk resistivity, and therefore bulk conductivity, of the water. Third, standard equations are used to convert conductivity and temperature into estimated salinity and density.

One complicating factor for measuring resistance is that any sort of DC measurement produces very unreliable results. Because the DC electric field disrupts the ions in the water, a DC resistance measurement produces unstable and unusable results. This behavior would be noted by one skilled in the art.

In a preferred embodiment, an AC waveform with a frequency greater than 1 kHz, and therefore a period less than 1 ms, is needed to make an accurate measurement. A typical solution is to build an AC voltage source, apply its voltage to the electrodes, and then attempt to detect the resistance or current from the resulting AC waveform. This becomes quite complicated, and so a simpler circuit was designed.

In a preferred embodiment, the sensor should have a digital interface and a minimal external component count.

To measure resistance, a simple resistor bridge 8 was constructed. The control resistance is a digitally controlled potentiometer 4 and the unknown resistance is the electrode pair immersed in saline solution. This permits resistance to be measured from a single physical parameter, as opposed to applying a known voltage and measuring current, and, by the nature of a bridge circuit, is very tolerant of variations in applied voltage.

To apply an AC voltage, an H-bridge 1 was added to drive the “top” and “bottom” of the bridge. The H-bridge 1 permits voltage to the resistor divider to be applied in a positive or negative polarity or to be completely removed from the circuit.

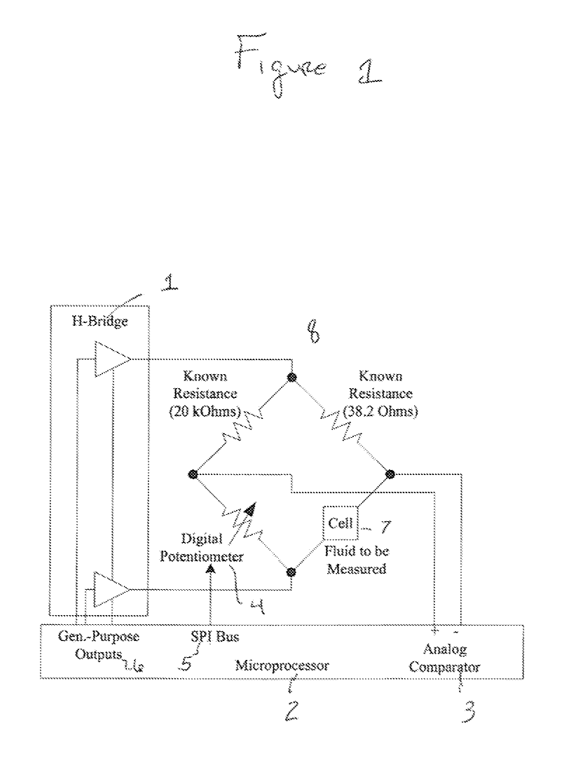

The “output” of the bridge 1 (the two voltages at the junctions of the known and varying resistances) is fed into the microcontroller's analog comparator 3. The output of the comparator 3 is a one-bit digital indicator of relative voltage between the two legs of the bridge. The circuit is shown below in FIG. 1. The “upper right” resistance was selected empirically so that the bridge balanced at low salinity levels

The H-bridge 1 was connected to the circuit's main 5V supply. Since the selected H-bridge 1 uses bipolar transistors, the voltage across the bridge 1 was approximately 3.5V.

### A. Microcontroller Interface

The microcontroller 2 sets the digitally controlled resistance, enables the bridge 1, reads the analog comparator 3 output, and then immediately disables the bridge 1. It also alternates the polarity of the bridge 1 voltage at each measurement, and so the result is a low-duty-cycle AC voltage. The microcontroller 2 simply steadily increases the potentiometer's 4 resistance until the bridge's 1 “output” polarity reverses. If the controller reaches maximum resistance without a reversal, then the resistance of the water is too high and the salinity must be extremely low, less than two parts per thousand (ppt).

The interface uses the Serial Peripheral Interface (SPI) bus 5 to set the resistance and three general-purpose outputs 6 to control the bridge 1. The feedback from the circuit is the two analog-comparator 3 inputs.

An Analog Devices AD8402 10 kΩ digital potentiometer 4 and a Texas Instruments L293D H-bridge 1 were selected, and the circuit was constructed using DIP-package components and a breadboard. A simple set of test software was written to control the system and read the results using a serial port.

When first connected, the measured resistance of the potentiometer 4 was extremely low at low salinity (10 ppt), which meant that the cell constant was much lower than expected. The resistor 8 in series with the cell 7 was reduced to 38.2 ohms (56 ohms in parallel with 120 ohms) to compensate and measurements were obtained.

To make the measurements, a beaker was filled with 1000 ml of water and 10 ml of table salt (approximately 10 g) was added, approximately 10 ppt of salt. The beaker was located on a magnetic stirring system to insure good dissolution of the salt. After measuring resistance, salt was added in 5 ml (5 ppt) increments and the resistance measurements recorded.

The results are tabulated below in Table 1.

TABLE I
MEASURED CONDUCTANCE VERSUS SALINITY LEVEL

| | Digital | Digital | Measured | Measured | Bulk |
|---|---|---|---|---|---|
| Salt | Pot | Pot | Cell | Cell | Conductivity |
| content | Wiper | Resistance | Resistance | Conductance | at 20° C. |
| (ppt) | Setting | (ohms) | (Ohms) | (mS) | (mS/cm) |
| 10 | 71 | 2784 | 5.32 | 188.0 | 15.6 |
| 15 | 51 | 2000 | 3.82 | 261.8 | 22.4 |
| 20 | 39 | 1529 | 2.92 | 342.3 | 29 |
| 25 | 33 | 1294 | 2.47 | 404.6 | 35.4 |
| 30 | 28 | 1098 | 2.10 | 476.8 | 41.7 |
| 35 | 25 | 980 | 1.87 | 534.0 | 47.9 |
| 40 | 22 | 863 | 1.65 | 606.9 | 53.9 |

Since the digital potentiometer 4 has an 8-bit “Wiper” register and has a maximum resistance of 10 kOhms, the value of Digital Pot Resistance is computed by dividing the wiper setting by 255 and multiplying by 10,000. The Measured Cell Resistance (resistance measured between the two immersed electrodes) was computed from the ratio of the known resistors in the resistor bridge, and the Measured Cell Conductance is the reciprocal of the resistance. The result is the measured conductance of the water between the electrodes as a function of salt content. The values of bulk conductivity in the last column are based on the standard model of conductivity, and are tabulated in [14]. (A temperature of 20° C. was used because the room temperature at the time of measurement was 21° C.) The Measured Cell Conductance (reciprocal of measured cell resistance) showed a roughly straight-line behavior, which indicated the system was working correctly.

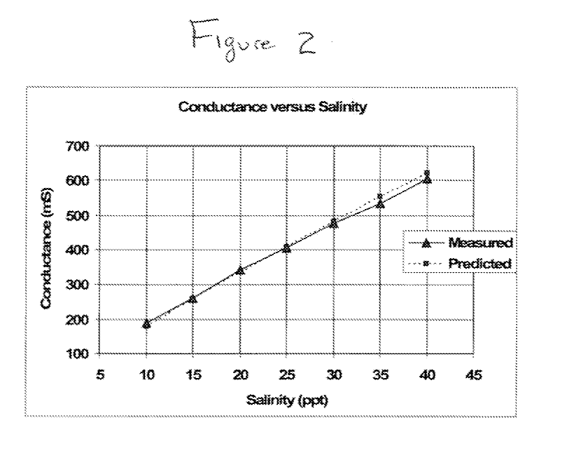

Since the cell constant C of the electrode structure was not known ahead of time, the following process was used to estimate it. First, for each salinity level, the standard-model bulk conductivity was divided by the measured conductance to estimate the cell constant, as shown in FIG. 2. Second, the value of cell constant was averaged over the seven samples to result in an average estimated cell constant of 0.0867 cm⁻¹. The measured conductivity of the water is plotted against the standard model of the conductivity of water using a cell constant of 0.0867 in FIG. 2 below.

In FIG. 2, the “measured” line is the measured resistance data from Table 2, converted to conductance by taking the reciprocal. The “predicted” line is from the standard-model bulk conductivity divided by a cell constant of 0.0867. The agreement of the measured and predicted conductance is good, with a correlation coefficient of 99.96%, indicating that the sensor is suitable for accurate salinity measurements

The salinity sensor as shown in FIG. 1 worked very well. It provides a low-cost solution for measuring salinity, taking into account the need for an AC waveform.

In addition to testing the cell 7 over a wider range of temperature and salinity conditions, there are some steps that can be taken to improve the design. First, if fewer general-purpose outputs are available, the SPI bus 5 could be shared between the potentiometer 4 and a shift register to control the H-bridge 1. This would reduce the number of outputs needed by two (because one output would still be needed to select the shift register). Second, a CMOS H-bridge device 1 can be selected to reduce DC power consumption, especially when the H-bridge 1 is disabled. This is an important consideration for battery life. Third, digital potentiometers 4 could be used in parallel if greater accuracy was needed. For example, the addition of a 100 kΩ potentiometer would permit a finer-grained conductance measurement.

### REFERENCES

[1] P. Villa and M. Gianinetto, “Multispectral Transform and Spline Interpolation for Mapping Flood Damages”, IEEE International Conference on Geoscience and Remote Sensing Symposium (IGARSS 2006), pp. 275-278.
[2] B. O'Flyrm, R. Martinez, J. Cleary, C. Slater, F. Regan, D. Diamond, and H. Murphy, “SmartCoast: A Wireless Sensor Network for Water Quality Monitoring”, 32nd IEEE Conference on Local Computer Networks (LCN 2007), pp. 815-816.
[3] E. Thosteson, E. Widder, C. Cimaglia, J. Taylor, B. Burns, and K. Paglen, “New technology for Ecosystem-Based Management: Marine monitoring with the ORCA Kilroy Network”, OCEANS 2009—EUROPE (OCEANS '09)
[4] A. Comeau, M. Lewis, J. Cullen, R. Adams, J. Andrea, S. Feener, S. McLean, K. Johnson, L. Coletti, H. Jannasch, S. Fitzwater, C. Moore, and A. Barnard, “Monitoring the Spring Bloom in an Ice Covered Fjord with the Land/Ocean Biogeochemical Observatory (LOBO)”, OCEANS 2007 (OCEANS '07)
[5] http://satlantic.com/lobo, Accessed Nov. 23, 2009
[6] http://recon.sccf.org/index.shtml, Accessed Nov. 24, 2009
[7] S. Silva, S. Cunha, A. Matos, and N. Cruz, “Shallow water height mapping with interferometric synthetic aperture sonar”, OCEANS 2008 (OCEANS '08)
[8] W. Schroeder and W. Wiseman Jr. “Low-frequency shelf-estuarine exchange processes in Mobile Bay and other estuarine systems on the northern Gulf of Mexico”, In Estuarine Variability, Ed. D. A. Wolfe. New York, N.Y.: Academic Press, 1986, pp. 355-366.
[9] C.-K. Kim, K. Park, H.-S. Jung, H-S., and W. Schroeder, “A hydrodynamic modeling study of physical transport in Mobile Bay and Eastern Mississippi Sound, Alabama”, Paper submitted to Estuaries and Coasts, 2008.
[10] W. Van Dorn, “Wind stress on an artificial pond”, Journal of Marine Research, Vol. 12, No. 3, 1953, pp. 249 276.
[11] A. Greenberg, L. Clesceri, and A. Eaton, eds., Standard Methods for the Examination of Water and Wastewater, 18th Edition, Washington DC: The American Public Health Association, 1992, pp. 2-46-2-48.
[12] T. Meindl, W. Moniaci, E. Pasero, and M. Riccardi, “An Embedded Hardware-Software System to Detect and Foresee Road Ice Formation,” International Joint Conference on Neural Networks (IJCNN '06), pp. 4884-4891.
[13] http://www.octiva.net/projects/ppm/, Accessed Nov. 22, 2009
[14] From http://www.envcoglobal.com/files/u5/Envco%20Conductivity%20to%20salinity%20conversion%20table.pdf based on equations obtained from P. Weyl, “On the Change in Electrical Conductance of Seawater with Temperature”, Limnology and Oceanography, Vol. 9, No. 1 (January 1964), pp. 75-78.

We claim:

1. A process for measuring the resistance of a fluid comprising the steps of:
a. providing a bridge circuit consisting of two known resistances, one digitally controlled resistance, one set of electrodes in contact in the fluid to be measured, and an analog comparator that provides an output compatible with digital logic levels;
b. providing means of reversing the polarity of the voltage applied to the bridge
c. varying the digitally controlled resistance and observing the digital output of the analog comparator;
d. observing the resistance setting of the digitally controlled resistance at the point of logic transition of the comparator; and
e. utilizing said resistance setting and the known properties of the bridge circuit to calculate the resistance of the fluid;

2. The process of claim 1 further comprising the step of using the electrodes' known cell constant to calculate the bulk conductivity of the fluid.

3. The process of claim 2 further comprising the step of using the bulk conductivity to estimate the fluid's salinity.

4. The process of claim 1 wherein the digitally controlled resistance is a digital potentiometer.

5. The process of claim 1 wherein the digitally controlled resistance is multiple digital potentiometers wired together.

6. The process of claim 1 wherein the fluid is seawater or other naturally occurring water.

7. The process of claim 1 wherein the electrodes are made of non-corrosive material.

8. The process of claim 1 wherein the means of reversing the polarity is an H-bridge.

9. The process of claim 1 wherein the means of reversing the polarity is a transistor network.

10. The process of claim 1 wherein the means of reversing the polarity is digitally controlled.

11. The process of claim 1 wherein at least one of the digitally controlled resistance, H-bridge, and analog comparator is built into a microprocessor.

12. The process of claim 1 wherein a shift register is added to reduce the number of output pins needed by the computer that is controlling the circuit.

13. An apparatus for measuring the resistance of a fluid comprising:
a. a bridge circuit consisting of two known resistances, one digitally controlled resistance, one set of electrodes in contact in the fluid to be measured, and an analog comparator that provides an output compatible with digital logic levels;
b. means for reversing the polarity of the voltage applied to the bridge
c. means for varying the digitally controlled resistance and observing the digital output of the analog comparator;
d. means for observing the resistance setting of the digitally controlled resistance at the point of logic transition of the comparator; and
e. means for utilizing said resistance setting and the known properties of the bridge circuit to calculate the resistance of the fluid.
